(19) United States
(12) Patent Application Publication
(10) Pub. No.: US 2006/0019691 A1
(43) Pub. Date: Jan. 26, 2006

(54) Method and system for evaluating the efficacy of locally-applied anti-proliferative or other agents on neointimal hyperplasia, immunohistochemical and vascular cell cycle changes in injured or atherosclerotic rabbit central ear arteries

(76) Inventors: Robert Falotico, Belle Mead, NJ (US); Tom Jay Parry, Hellertown, PA (US); Jonathon Z. Zhao, Belle Mead, NJ (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 10/895,548

(22) Filed: Jul. 21, 2004

(51) Int. Cl. H04Q 7/20

(52) U.S. Cl. 455/518

(57) ABSTRACT

A methodology for percutaneously accessing the central ear artery of a rabbit may be utilized for inducing, treating and evaluating injuries therein to determine the pathology of the injuries and the safety and efficacy of the treatment. The central ear artery of a rabbit is similar to morphology to human coronary arteries. Accordingly, the study of the central ear artery of a rabbit will provide valuable information in the biology and identification of new treatments for restenosis, atherosclerosis and vulnerable plaque.

### BACKGROUND OF THE INVENTION

1. Field of the Invention

The present invention relates to methods and systems for evaluating mammalian arteries, and more particularly to methods and systems for evaluating pathologies and therapeutics in rabbit central ear (auricular) arteries.

2. Discussion of the Related Art

A number of model systems have been developed to evaluate the safety and efficacy of therapeutic agents in reducing restenosis following vascular injury. Conduit arteries of various animals, for example, the carotid artery, the iliac arteries and the aorta, have been commonly utilized in the assessment of potential anti-restenosis therapies. However, these arteries are elastic in nature, having distinct layers of smooth muscle cells separated by concentric elastic lamina. The coronary arteries; however, are muscular in nature, lacking the multiple concentric elastic lamina within the arterial media.

The rabbit central ear artery, or auricular artery, shares morphologic characteristics with human coronary arteries of similar size, approximately 1.5 to 2.5 mm diameter, in that the central ear artery is a morphologically muscular vessel. In addition, endovascular access to the central ear artery is remarkably simple as cannulation and introduction of catheters need only require direct visualization without the need for fluoroscopy. Investigators have utilized the rabbit central ear artery as a model for studying vascular responses to extravascular injury by application of direct pressure on the skin over and underlying the central ear artery. Additionally, investigators have evaluated potential anti-restenotic therapies utilizing this extravascular injury approach. However, no investigators have described the use of transluminally applied devices to injure or apply therapeutics/devices to the luminal surface of the central ear artery of a rabbit.

Accordingly, there exists a need for a methodology of percutaneous access and percutaneous access devices for inducing endovascular injury as well as the application of potential therapeutic agents and devices in the central ear artery of a rabbit.

### SUMMARY OF THE INVENTION

The present invention overcomes the limitations associated with currently utilized animal models as briefly described above.

In accordance with one aspect, the present invention is directed to a method for evaluating pathologies in a rabbit central ear artery. The method comprises the steps of endovascularly creating an injury in at least one location within the central ear artery of a rabbit and evaluating the pathologies associated with the injury.

In accordance with another aspect, the present invention is directed to a method for evaluating therapeutics in a rabbit central ear artery. The method comprises the steps of endovascularly creating an injury in at least one location within the central ear artery of a rabbit, treating the injured artery and evaluating the pathologies associated within the treated injured artery and the efficacy of the treatment.

In accordance with another aspect, the present invention is directed to a method for evaluating pathologies in a rabbit central ear artery. The method comprises the steps of creating an atherosclerotic/inflammatory lesion at at least one location within a central ear artery of a rabbit and evaluating the pathologies associated with the injury.

In accordance with another aspect, the present invention is directed to a method for evaluating therapeutics in a rabbit central ear artery. The method comprises the steps of creating an atherosclerotic/inflammatory lesion at at least one location within a central ear artery of a rabbit, treating the injured artery and evaluating the pathologies associated with the treated injured artery and the efficacy of the treatment.

The present invention allows for the percutaneous induction of endovascular injury and drug and/or device delivery to the rabbit central ear artery without the need for fluoroscopy. The use of the rabbit central ear artery further models the morphology of muscular human coronary arteries. The present invention offers relatively rapid throughput and lower cost than the typical porcine model. The combination of these techniques allow for the evaluation of both the potential therapeutic benefit of local drug treatment on blocking neointimal hyperplasia, the major component of restenosis following revascularization procedures and treating atherosclerotic lesions, including vulnerable plaque, and for gaining an understanding of the mechanics at the cellular and molecular level by which locally or regionally applied drugs influence the vascular wall.

### BRIEF DESCRIPTION OF THE DRAWINGS

The foregoing and other features and advantages of the invention will be apparent from the following, more particular description of preferred embodiments of the invention, as illustrated in the accompanying drawings.

FIG. 1 is a diagrammatic representation of a percutaneous delivery of a stent into a central ear artery of a rabbit in accordance with the present invention.

FIG. 2 is a low power photomicrograph of a stented rabbit central ear artery in accordance with the present invention.

### DETAILED DESCRIPTION OF THE PREFERRED EMBODIMENTS

The present invention is directed to a methodology or model for the evaluation of the effects of percutaneously/transluminally applied medical devices, including stents and/or therapeutic agents delivered via stents or delivery catheters, such as infusion balloon catheters, in the central ear arteries of rabbits. This methodology or model may serve as a means for the evaluation of therapeutic agents for the treatment of vascular diseases, including restenosis and vulnerable plaque, and may also serve to model safety and efficacy testing of any number of endovascularly applied therapeutic agents in the context of normal or atherosclerotic muscular arteries. Essentially, the present invention utilizes percutaneous access devices for inducing endovascular injury, the application of potential therapeutic devices and agents for treating the induced injuries, and for evaluating the safety and efficacy of the therapeutics. The endovascular injury may be induced via other means, including diet, perivascular injection of proinflammatory agents and/or systemic drug delivery. In addition, the application of standard endpoint evaluation, intravital microscopy, including angiography, intravascular ultrasound imaging, histological, molecular and cellular endpoints, may be utilized in conjunction with the percutaneous approach into the central ear arteries of rabbits in accordance with the present invention.

The methodology of the present invention comprises a number of procedures or steps. The methodology should be understood not to be limited to the particular devices and therapeutic agents and/or other drugs described herein. The exemplary methodology shall be described with respect to the Watanabe rabbit; however, other rabbit strains may be utilized.

The initial step in the methodology involves the pre-treatment of the rabbit. The rabbit may preferably be pre-treated, prior to the actual procedure, with a calcium channel blocker, for example, verapamil, for prophylaxis against procedural vascular injury induced vasospasm. The pre-treatment may be administered from about six to twelve hours prior to the procedure. Utilizing the rabbit's marginal ear vein, nitroprusside at 100 μg/kg/min and/or a reversible alpha 1 receptor antagonist, for example, prazosin at 0.25 to 1 mg/kg, may be administered at the time of the procedure to serve as additional prophylaxis against injury induced vasospasm. The rabbit may also be pre-treated with anti-thrombotics, for example, aspirin with or without clopidogrel to control the platelet component of arterial thrombosis in response to endovascular injury. The humoral factors associated with thrombosis secondary to arterial injury may be controlled by the periprocedural administration of heparin.

Next, the rabbit is anesthetized. The rabbit may be anesthetized utilizing any number of anesthetizing agents. For example, the rabbit may be anesthetized with an injectable anesthetic such as a mixture of ketamine and xylazine with or without a neuroleptic (e.g. acepromazine) or an appropriate inhalational anesthetic such as halothane. The rabbit is then preferably placed on a warming pad set to maintain a temperature of approximately thirty-seven degrees centigrade. The dorsal surfaces of the rabbit's ear or ears are shaved and swabbed with ethanol or isopropyl alcohol, both to disinfect and dilate the central ear artery in each ear.

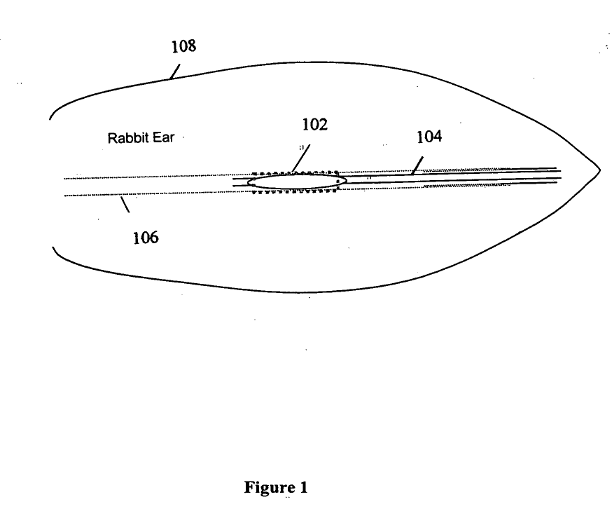

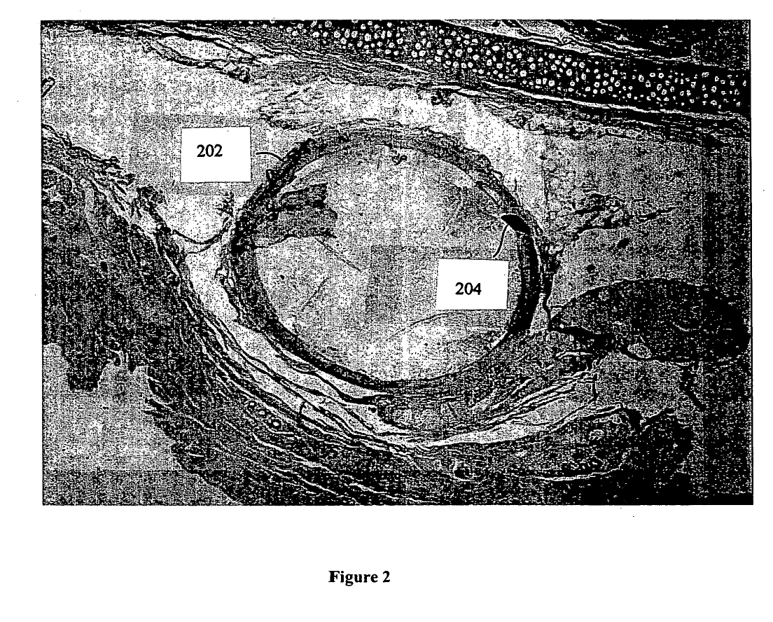

Once fully prepped, a sixteen to eighteen gauge polytetrafluoroethylene (PTFE) introducer tube, with a longitudinally extending slit to enable easy breakaway from the intended catheter, over a suitable sixteen to eighteen gauge hypodermic needle is introduced percutaneously into the target central ear artery distal to the point of central ear artery injury, treatment and evaluation. Through the lumen of the introducer tube, a balloon catheter, which depending on the particular procedure may be an angioplasty balloon catheter, a balloon drug delivery catheter or a stent delivery balloon catheter, is advanced proximally into the target central ear artery. The central ear artery dimensions could theoretically accommodate a device that is expandable to 1.5 to 2.0 mm with a length of up to 2.5 to 3.0 cm. Once in position, the balloon is inflated, therapeutic agents are delivered and/or stents are deployed. As described in more detail below, the particular procedure depends on the particular application. The balloon is then deflated. The inflation of the balloon may be repeated to ensure optimal injury, drug delivery and/or stent deployment against the vessel wall. FIG. 1 illustrates a stent 102 deployed by a stent delivery catheter 104 in the central ear artery 106 of a rabbit's ear 108. The catheter is then withdrawn and bleeding is controlled with direct pressure. Vetbond or equivalent, n-butylcyanoacrylate tissue adhesive, may also be utilized to control bleeding through the percutaneous wound site. The procedure may be done on one ear or both ears. Following the procedure or procedures, the rabbit is transferred to a recovery cage and observed for breakthrough bleeding and other post-operative problems until the rabbit regains consciousness. The rabbit is then transferred to its home cage for extended recovery for up to six months. The recovery time depends on the procedure and the final evaluation to be performed. Referring now to FIG. 2, there is illustrated a low power photomicrograph of a stented rabbit central ear artery. The artery is indicated by reference numeral 202 and a strut of the stent by reference numeral 204. As may be seen from the photomicrograph, some evidence of the stent is left and embedded in the artery wall, and the vessel is substantially round having taken the shape of the deployed sent.

As described above, the exact procedure depends on the application. For example, if the procedure is to cause the initial injury, a balloon may be introduced and inflated and deflated a number of times to cause the injury. If the procedure is to stent the vessel, then a balloon expandable or self-expanding stent may be introduced. If the procedure is to introduce therapeutic agents, a stent with one or more therapeutic agents may be introduced, or a perfusion balloon may be utilized to directly deliver the one or more therapeutic agents. If the procedure is to perform various tests, angiographic catheters or other percutaneously delivered devices may be utilized. In addition, all of these different procedures, devices and therapeutic agents may be utilized in combination. In an alternate exemplary embodiment, energy based, catheter delivered systems may be utilized to induce endovascular injury. For example, ultrasonic transducers may be utilized as well as radiofrequency devices.

Also as described above, the injury may be induced by alternate means. For example, vulnerable plaque may be investigated. In order to investigate vulnerable plaque, a vulnerable plaque lesion should be created. The creation of a lesion may be accomplished through diet, for example, high fat/cholesterol content and/or through systemic or local drug delivery. For example, subcutaneous injection of proinflammatory agents, including lipopolysaccharide (endotoxin) may be utilized to create a lesion. Once the lesion is created, the methodology of the present invention may be utilized to investigate the nature of the lesion, i.e. lipid core and thin fibrous cap, and/or treat the lesion. In utilizing this procedure, atherosclerosis and vulnerable plaque may be approximated and various treatments may be studied. Also, the effects of the disease may also be studied.

In a preferred exemplary embodiment, the induction of atherosclerotic plaque and vulnerable atheroslerotic plaque may be achieved as follows. First, a mild injury is induced by the application of external pressure to the central ear artery of the rabbit or by endovascular balloon/stent injury in either normal or atherosclerotic rabbit strains (Watanabe). The central ear artery would then be exposed perivascularly to an agent that promotes recruitment of macrophages, for example, perivascular injection of lipopolysaccaride (endotoxin) derived from E. coli. The pathology of the resulting vascular lesion would then be followed over time. This model may exhibit characteristics of vulnerable plaque and may be amenable to either endovascular, perivascular or systemic treatment approaches

The methodology of the present invention provides for the gathering of a substantial amount of information. An artery similar to human coronary arteries may be percutaneously assessed without the need for fluroscopy. Through this percutaneous access, the artery may be injured, the injury may be treated and finally the injury and the treatment may be evaluated. The final evaluation may be a gross examination or it may involve an investigation at the cellular and molecular level. Any number of therapeutic agents may be applied either locally, regionally or systematically and their effects studied. For example, disease states such as restenosis, atherosclerosis and vulnerable plaque may be studied. In addition, the actions and effects of various therapeutic agents, e.g. rapamycin or restenosis, may be investigated utilizing the methodology of the prevention. It is important to note that any number of conditions, diseases and treatments may be investigated. It is also important to note that perivascular devices and treatments may be used in addition to endovascular devices described herein. For example, perivascular wraps may be utilized to deliver therapeutic agents.

A partial list of therapeutic and pharmaceutical agents that may be utilized alone or in conjunction with implantable medical devices include antiproliferative/antimitotic agents including natural products such as vinca alkaloids (i.e. vinblastine, vincristine, and vinorelbine), paclitaxel, epidipodophyllotoxins (i.e. etoposide, teniposide), antibiotics (dactinomycin (actinomycin D) daunorubicin, doxorubicin and idarubicin), anthracyclines, mitoxantrone, bleomycins, plicamycin (mithramycin) and mitomycin, enzymes (L-asparaginase which systemically metabolizes L-asparagine and deprives cells which do not have the capacity to synthesize their own asparagine); antiplatelet agents such as G(GP) II_{b}/IIIₐ inhibitors and vitronectin receptor antagonists; antiproliferative/antimitotic alkylating agents such as nitrogen mustards (mechlorethamine, cyclophosphamide and analogs, melphalan, chlorambucil), ethylenimines and methylmelamines (hexamethylmelamine and thiotepa), alkyl sulfonates-busulfan, nitrosoureas (carmustine (BCNU) and analogs, streptozocin), triazenes—dacarbazinine (DTIC); antiproliferative/antimitotic antimetabolites such as folic acid analogs (methotrexate), pyrimidine analogs (fluorouracil, floxuridine, and cytarabine), purine analogs and related inhibitors (mercaptopurine, thioguanine, pentostatin and 2-chlorodeoxyadenosine {cladribine}); platinum coordination complexes (cisplatin, carboplatin), procarbazine, hydroxyurea, mitotane, aminoglutethimide; hormones (i.e. estrogen); anticoagulants (heparin, synthetic heparin salts and other inhibitors of thrombin); fibrinolytic agents (such as tissue plasminogen activator, streptokinase and urokinase), aspirin, dipyridamole, ticlopidine, clopidogrel, abciximab; antimigratory; antisecretory (breveldin); anti-inflammatory: such as adrenocortical steroids (cortisol, cortisone, fludrocortisone, prednisone, prednisolone, 6α-methylprednisolone, triamcinolone, betamethasone, and dexamethasone), non-steroidal agents (salicylic acid derivatives i.e. aspirin; para-aminophenol derivatives i.e. acetaminophen; indole and indene acetic acids (indomethacin, sulindac, and etodalac), heteroaryl acetic acids (tolmetin, diclofenac, and ketorolac), arylpropionic acids (ibuprofen and derivatives), anthranilic acids (mefenamic acid, and meclofenamic acid), enolic acids (piroxicam, tenoxicam, phenylbutazone, and oxyphenthatrazone), nabumetone, gold compounds (auranofin, aurothioglucose, gold sodium thiomalate); immunosuppressives: (cyclosporine, tacrolimus (FK-506), sirolimus (rapamycin), azathioprine, mycophenolate mofetil); angiogenic agents: vascular endothelial growth factor (VEGF), fibroblast growth factor (FGF); angiotensin receptor blockers; nitric oxide donors; oligionucleotides and combinations thereof; cell cycle inhibitors, mTOR inhibitors, and growth factor receptor signal transduction kinase inhibitors; retenoids; cyclin/CDK inhibitors; HMG co-enzyme reductase inhibitors (statins); and protease inhibitors.

After the appropriate recovery period, the rabbit is euthanized by overexposure to carbon dioxide. The treated segments and/or control untreated segments of ear surrounding the central ear artery are excised and placed in a fixation agent, such as formalin. The rabbit may also be perfused transcardially for in situ fixation. If no fixation is desired, the rabbit's central ear arteries may be harvested, frozen or processed without freezing to evaluate such endpoints as vascular mRNA, protein expression (histoloigically or by ELISA), or FACs analysis, including cell cycle and apoptosis determination.

As stated above, the central ear arteries may be subjected to any number of tests. The central ear arteries may be tested or evaluated to determine the injury or disease pathology and/or the efficacy of various therapeutics. The range of tests runs from gross physical examination to cellular and molecular level testing. The central ear arteries may be subjected to standard histological preparation and staining procedures. Such procedures include elastic lamina staining, e.g. elastic Verhoff van Geison stain, H&E and collagen staining. The central ear arteries may be subjected to quantitation of luminal, neointimal, medial and adventitial surface areas, histopathologic examination, evaluation of inflammatory responses, assessment of apoptosis and proliferative responses by immunohistochemistry (cell proliferation and apoptosis are evaluated using anti-Proliferating Cell Nuclear Antigen (PCNA) and Terminal deoxynucleotide tranferase-mediated dUTP nick-End Labeling (TUNEL) immunohistochemistry) or other methods, or quantitation of extracellular matrix changes.

For the assessment of vascular cell cycle, the central ear arteries are harvested between one and ten days post-injury, and preferably three or seven days, from the euthanized rabbits. The central ear arteries are then thoroughly minced utilizing crossed scalpels and placed in a DMSO/citrate/sucrose cryoprotection solution. The mincate is then snap-frozen and stored at minus eighty degrees centigrade for subsequent analysis. Upon analysis, the mincate is treated with a trypsin/detergent solution that effectively extrudes cell nuclei from the mincate. The digestion is then terminated, the suspension centrifuged and the resulting nuclear suspension is treated with propidium iodide, forming a fluorescent complex with nuclear DNA. The propidium iodide stained nuclear suspension is then drawn into a flow cytometer gated to eliminate debris and doublet nuclei for quantitation of fluorescence intensity. The resulting fluorescence is proportional to the amount of DNA in each nucleus. Approximately 12,000 to 20,000 events are obtained for subsequent analysis of cell cycle histograms. Cell cycle analysis is performed following acquisition of the DNA histograms using the MODFIT cell cycle analysis algorithm. Alternately, other cell markers may be analyzed utilizing flow cytometry from whole cell preparations of minced central ear arteries. This may include smooth muscle α-actin, PCNA, BrdU, Mac-1, integrins and cell surface receptors.

Mincates from injured, non-injured and/or treated central ear arteries may be subjected to RNA extraction and subsequent gene expression utilizing quantitative RT-PCR and/or gene chip analysis. Gene expression may also be evaluated in cryo-sections of snap-frozen treated/injured and/or non-injured central ear arteries utilizing in situ hybridization followed by film autoradiography, emulsion autoradiography or fluorescence (FISH). Protein expression may be evaluated by immunohistochemistry or from protein extracts of minced treated/injured and/or non-injured central ear arteries utilizing ELISA's or other assays.

The effects of local drug delivery on multiple histologic endpoints may also be evaluated utilizing standard histological preparations, immunohistochemistry preparations and gene expression (mRNA or protein). Examples of standard histological preparations include staining for vascular components, including cell matrix, infiltrating leukocytes, endothelial cells and perivascular connective tissue, and quantitation of cell number based upon staining patterns and cell morphology, e.g. number of leukocytes, endothelial cells, surface area of matrix and the like. Examples of immunohistochemistry preparations include immunohistochemical evaluation of cell marker expression, e.g. Mac-1 macrophage markers, smooth muscle α-actin, tubulin, endothelial cell markers, lipids, markers of proliferation and apoptosis. Examples of gene expression include evaluation from RNA extracted from minced treated/injured or non-injured vessels using quantitative RT-PCR or gene chip analysis. Protein expression may be evaluated from protein extracts of treated/injured or non-injured vessels using ELISA's or other quantitative protein assays.

As stated above, injuries, diseases and treatments may be evaluated utilizing the methodology of the present invention. Accordingly, the efficacy of various agents, such as rapamycins, may be safely and effectively studied. Accordingly, the present invention, provides for the safe and effective analysis of disease states and treatments therefore.

Although shown and described is what is believed to be the most practical and preferred embodiments, it is apparent that departures from specific designs and methods described and shown will suggest themselves to those skilled in the art and may be used without departing from the spirit and scope of the invention. The present invention is not restricted to the particular constructions described and illustrated, but should be constructed to cohere with all modifications that may fall within the scope of the appended claims.

What is claimed is:

1. A method for evaluating pathologies in a rabbit central ear artery comprising:
endovascularly creating an injury in at least one location within the central ear artery of a rabbit; and
evaluating the pathologies associated with the injury.

2. The method for evaluating pathologies according to claim 1, wherein the step of endovascularly creating an injury in at least one location within the central ear artery of a rabbit comprises percutaneously delivering a balloon catheter and inflating a balloon to cause an endovascular injury.

3. The method for evaluating pathologies according to claim 1, wherein the step of endovascularly creating an injury in at least one location within the central ear artery of a rabbit comprises percutaneously delivering and deploying a stent to cause an endovascular injury.

4. The method for evaluating pathologies according to claim 1, wherein the step of endovascularly creating an injury in at least one location within the central ear artery of a rabbit comprises percutaneously delivering at least one agent to cause an endovascular injury.

5. The method for evaluating pathologies according to claim 1, wherein the step of endovascularly creating an injury in at least one location within the central ear artery of a rabbit comprises percutaneously delivering and employing an energy transducer to cause an endovascular injury.

6. The method for evaluating pathologies according to claim 1, wherein the step of evaluating the pathologies associated with the injury comprises performing histological studies.

7. The method for evaluating pathologies according to claim 1, wherein the step of evaluating the pathologies associated with the injury comprises performing molecular studies.

8. The method for evaluating pathologies according to claim 1, wherein the step of evaluating the pathologies associated with the injury comprises performing gross and microscopic pathology studies.

9. The method for evaluating pathologies according to claim 1, wherein the step of evaluating the pathologies associated with the injury comprises performing cell cycle analysis.

10. The method for evaluating pathologies according to claim 1, wherein the step of evaluating the pathologies associated with the injury comprises performing marker expression analysis.

11. A method for evaluating therapeutics in a rabbit central ear artery comprising:
endovascularly creating an injury in at least one location within the central ear artery of a rabbit;
treating the injured artery; and
evaluating the pathologies associated with the treated injured artery and the efficacy of the treatment.

12. The method for evaluating therapeutics according to claim 11, wherein the step of endovascularly creating an injury in at least one location within the central ear artery of a rabbit comprises percutaneously delivering a balloon catheter and inflating a balloon to cause an endovascular injury.

13. The method for evaluating therapeutics according to claim 11, wherein the step of endovascularly creating an injury in at least one location within the central ear artery of a rabbit comprises percutaneously delivering and deploying a stent to cause an endovascular injury.

14. The method for evaluating therapeutics according to claim 11, wherein the step of endovascularly creating an injury in at least one location within the central ear artery of a rabbit comprises percutaneously delivering at least one agent to cause an endovascular injury.

15. The method for evaluating therapeutics according to claim 11, wherein the step of endovascularly creating an injury in at least one location within the central ear artery of a rabbit comprises percutaneously delivering and employing an energy transducer to cause an endovascular injury.

16. The method for evaluating therapeutics according to claim 11, wherein the step of treating the injured artery comprises the local delivery of one or more therapeutic agents.

17. The method for evaluating therapeutics according to claim 11, wherein the step of treating the injured artery comprises the implantation of one or more stents.

18. The method for evaluating therapeutics according to claim 11, wherein the step of treating the injured artery comprises perivascular treatment.

19. The method for evaluating therapeutics according to claim 11, wherein the step of treating the injured artery comprises systemic therapeutic agent delivery.

20. The method for evaluating therapeutics according to claim 11, wherein the step of evaluating the pathologies associated with the treated injury comprises performing histological studies.

21. The method for evaluating therapeutics according to claim 11, wherein the step of evaluating the pathologies associated with the treated injury comprises performing molecular studies.

22. The method for evaluating therapeutics according to claim 11, wherein the step of evaluating the pathologies associated with the treated injury comprises performing gross and microscopic pathology studies.

23. The method for evaluating therapeutics according to claim 11, wherein the step of evaluating the pathologies associated with the treated injury comprises performing cell cycle analysis.

24. The method for evaluating therapeutics according to claim 11, wherein the step of evaluating the pathologies associated with the treated injury comprises performing marker expression analysis.

25. A method for evaluating pathologies in a rabbit central ear artery comprising:
creating an atherosclerotic/inflammatory lesion at at least one location within a central ear artery of a rabbit; and
evaluating the pathologies associated with the injury.

26. A method for evaluating therapeutics in a rabbit central ear artery comprising:
creating an atherosclerotic/inflammatory lesion at at least one location within a central ear artery of a rabbit;
treating the injured artery; and
evaluating the pathologies associated with the treated injured artery and the efficacy of the treatment.
